(19) United States
(12) Patent Application Publication
(10) Pub. No.: US 2025/0132565 A1
(43) Pub. Date: Apr. 24, 2025

(54) SYSTEM, CONTROLLER, AND METHOD FOR AUTOMATIC LOAD MANAGEMENT

(71) Applicant: SPONGE MICROGRIDS INC., Toronto (CA)

(72) Inventors: Jeremy Douglas Lytle, Toronto (CA); Arjun Ivimey, Toronto (CA)

(21) Appl. No.: 18/964,104

(22) Filed: Nov. 29, 2024

Related U.S. Application Data
(63) Continuation of application No. 18/921,612, filed on Oct. 21, 2024.
(60) Provisional application No. 63/592,066, filed on Oct. 20, 2023.

(51) Int. Cl. H02J 3/14; H02J 3/00

(52) U.S. Cl. CPC H02J 3/144; H02J 3/001; H02J 2203/10; H02J 2310/60

(57) ABSTRACT

A system for load management of circuits connected to circuit breakers of an electrical distribution panel comprises a housing distinct from the panel; connection ports on the housing each pair of which defines a load path for locating electrically in series between a breaker and a load in a corresponding circuit such that load current of the circuit passes through the load path; a first current measurement device in the housing to measure input current to the panel; circuit interrupter assemblies respectively in the load paths each comprising a current interrupting device and a current measurement device in series therewith; and a controller in operative communication with the first current measurement device and the circuit interrupter assemblies and configured to (i) receive input panel current measurements, (ii) receive load current measurements, and (iii) configure selected interrupting devices in open-circuit states responsive to a determination based on said current measurements.

This is a continuation application of U.S. patent application Ser. No. 18/921,612 filed Oct. 21, 2024, which claims the benefit under 35 U.S.C. 119 (e) of U.S. provisional application Ser. No. 63/592,066 filed Oct. 20, 2023.

### TECHNICAL FIELD

The following relates, generally, to building electrical power management, and more particularly, to a system, controller, and method for automatic load management.

### BACKGROUND

Generally, the total electric load on power grids around the world is projected to rapidly increase. In many cases, the infrastructure that serves these loads was designed and built decades ago, predicated on much less aggressive growth assumptions. As a result, in many cases, distribution grids may not be adequately equipped to handle the rapid upgrades to service capacity that will be required at grid edges. Where distribution infrastructure does have capacity to support edge upgrades, the costs of which will ultimately fall on the customers of the grid. This creates the substantial need for better load management at the grid edges.

### SUMMARY

In various aspects, there is provided a load management system, controller, and method for automatic load shedding. The system is associated with a building electrical panel. The building electrical panel comprises a plurality of electrical circuits. The load management system comprises: a service measurement device to measure service entrance current of the building electrical panel; an interrupting device and a load measurement device located in series with a load path for one or more electrical circuits in the plurality of electrical circuits, the load measurement device measures load current on the electrical circuit, the interrupting device disconnects or connects connection of the electrical circuit upon receiving associated instructions; and a controller in communication with the service measurement device, each of the interrupting devices, and each of the measurement devices, the controller comprising one or more processing units in communication with a data storage comprising executable instructions to: receive service entrance current measurements from the service measurement device; receive load currents from the load measurement device; and instructs specific interrupting devices to disconnect electrical connection in response to load or capacity, or both, based on the service entrance current measurements and the load currents.

In another aspect, there is provided a system for electrical load management. The system is associated with an electrical distribution panel having a plurality of circuit breakers electrically connected to a plurality of a load circuits. The electrical distribution panel is arranged to be connected to an external power source as to receive service entrance current. The system comprises:
a housing arranged to be distinct from the electrical distribution panel;
one or more pairs of connection ports supported by the housing and respectively defining a load path between respective ones of the pair of connection ports for locating electrically in series between one of the circuit breakers and a corresponding one of the load circuits such that load current of the corresponding load circuit passes through the load path;
a service measurement device supported by the housing and configured to measure the service entrance current of the electrical distribution panel;
one or more circuit interrupter assemblies respectively disposed along the load paths to receive the load currents arranged to pass therethrough, wherein each circuit interrupter assembly is supported within the housing and comprises an interrupting device and a load measurement device electrically connected in series therewith, wherein the load measurement device of each circuit interrupter assembly is configured to measure the load current and wherein the interrupting device is configured to selectively form an open-circuit state for disconnecting the corresponding load circuit; and
a controller in operative communication with the service measurement device and said one or more circuit interrupter assemblies, the controller comprising one or more processing units in communication with a data storage comprising executable instructions to:
   receive measurements of the service entrance current from the service measurement device;
   receive measurements of the load current from each load measurement device of the one or more circuit interrupter assemblies; and
   configure selected ones of the interrupting devices in the open-circuit states in response to a determination based on the measurements of the service entrance current and the load currents.

This provides an arrangement of load management system which is suited for packaging as a standalone or self-contained device, which may be more easily retrofitted with an existing building distribution panel, and which may function without connection to internet.

In an arrangement, the housing is configured to be mounted to a face of the electrical distribution panel, for example, an exterior face or an interior face. In this manner, the system may be more easily spatially or physically retrofitted in an existing electrical distribution panel.

In an arrangement, the executable instructions to configure selected ones of the interrupting devices to form the open-circuit states comprise instructions to configure all of the interrupting devices in the open-circuit states as to disconnect all of the load circuits in an outage operational mode.

In an arrangement, the system further includes a power terminal configured to be electrically connected to one of the circuit breakers to draw power from the electrical distribution panel.

In an arrangement, at least a first set of the connection ports and a first set of the circuit interrupter assemblies are carried on a master board carrying the controller and a power terminal configured to receive AC power, and a second set of the connection ports and a second set of the circuit interrupter assemblies are carried on a slave board in operative communication with the master board to receive the electrical power and the instructions of the controller from the master board.

In another arrangement, the controller and a power terminal configured to receive AC power are carried on a master board and the connection ports and the circuit interrupter assemblies are carried on one or more slave boards in operative communication with the master board to receive electrical power and the instructions of the controller from the master board.

In an arrangement in which the system includes a power terminal configured to electrically connect to the electrical distribution panel to receive AC power therefrom, the system further includes a voltage measurement device configured to measure voltage at the power terminal for determining voltage of the AC power signal from the electrical distribution panel.

In an arrangement, the executable instructions of the controller include instructions to determine at least one of power factor and phase association of the load path operatively electrically connected to a respective one of the electrical loads to determine instructions for operating the interrupting device of the corresponding circuit interrupter assembly.

In an arrangement, the executable instructions to configure selected ones of the interrupting devices in the open-circuit states comprises configuring a respective one of the interrupting devices corresponding to the load path with a highest one of the measured load currents.

In yet another aspect, there is provided a method for managing electrical loads connected to an electrical distribution panel having a plurality of circuit breakers, wherein the electrical loads are electrically connected to the circuit breakers as to form a plurality of circuits, the method comprising:
providing a load management system distinct from the electrical distribution panel, wherein the load management system comprises a service current measurement device for measuring input current to the electrical distribution panel and one or more circuit interrupter assemblies for measuring currents of the electrical circuits and selectively opening to interrupt flows of the currents;
electrically connecting one or more of the circuit interrupter assemblies in series with respective ones of the circuits between a corresponding one of the circuit breakers of the respective circuit and a corresponding one of the electrical loads of the circuits, wherein the circuit interrupter assemblies are connected between the corresponding circuit breaker and the corresponding load as to be downstream of the circuit breaker;
using the load management system, measuring the input current of the electrical distribution panel and the currents of the respective circuits connected to the load management system; and
causing, using the load management system, one or more of the circuit interrupter assemblies to open to disconnect corresponding ones of the electrical loads of selected ones of the circuits in response to a determination based on the input current and the currents of the connected circuits.

This provides an arrangement of load management system which may be more easily retrofitted in a building with existing circuits.

In an arrangement, the method further includes further including mounting the load management system to the electrical distribution panel. As such, the load management system does not occupy any additional surface area on a wall where the electrical distribution panel is mounted in the building.

In an arrangement, causing one or more of the circuit interrupter assemblies to open comprises operating the one or more circuit interrupter assemblies in an outage mode in which all of the interrupting devices are configured to be open in response to at least one of (i) the service entrance current being zero, and (ii) an external signal indicative of a power outage.

In an arrangement, the method further includes measuring, using the load management system, input voltage of the electrical distribution panel at electrical connection to one of the circuit breakers.

In an arrangement, the method further includes electrically connecting the load management system to one of the circuit breakers to draw operating power therefrom.

In an arrangement, the method further includes determining at least one of power factor and phase association of a respective one of the circuits to determine instructions for operating a corresponding one of the circuit interrupter assemblies to interrupt flow of the current.

In an arrangement, causing one or more of the circuit interrupter assemblies to open comprises causing a respective one of the circuit interrupter assemblies connected to a respective one of the circuits drawing a highest one of the measured currents to open.

In an arrangement, causing one or more of the circuit interrupter assemblies to open comprises toggling, between open and closed states, respective ones of the circuit interrupter assemblies connected to corresponding ones of the circuits including respective ones of the electrical loads of a flexible type, based on optimal energy usage information.

In one such arrangement, toggling respective circuit interrupter assemblies between open and closed states is performed responsive to an external signal from a supervisory controller configured to predict optimal energy usage.

These and other aspects are contemplated and described herein. It will be appreciated that the foregoing summary sets out representative aspects of the system, controller and method to assist skilled readers in understanding the following detailed description.

### DESCRIPTION OF THE DRAWINGS

A greater understanding of the embodiments will be had with reference to the Figures, in which:

FIG. 1 is a conceptual diagram illustrating a load management system (LMS) with a controller for flexible load management, in accordance with an embodiment;

FIG. 2 is a conceptual diagram illustrating an example architectural schematic of the LMS of FIG. 1;

FIG. 3 is a schematic diagram of an example of incorporation of the LMS of FIG. 1 into an existing breaker panel enclosure;

FIG. 4 is an example side-view of a mechanical schematic of an enclosure for the LMS of FIG. 1;

FIG. 5 is a flowchart illustrating a method for flexible load management, in accordance with an embodiment;

FIG. 6 is a diagram showing an example of an electrical distribution panel having a plurality of circuit breakers electrically connected to a plurality of a load circuits;

FIG. 7 is a diagram of an example arrangement of a controller and a power terminal configured to receive AC power, showing master board and connection ports, and circuit interrupter assemblies; and

FIG. 8 is a flowchart for a method of managing electrical loads connected to an electrical distribution panel having a plurality of circuit breakers which are electrically connected to the circuit breakers as to form a plurality of circuits, in accordance with an embodiment.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender. Further definitions for terms may be set out herein; these may apply to prior and subsequent instances of those terms, as will be understood from a reading of the present description.

Any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

Common instances of load growth at the level of a single-family residence might include, for example, a home renovation, purchase of an electric vehicle, fuel switching from gas to heat pumps, or building an additional dwelling unit. When the total calculated load (according to local electrical codes) on a main distribution panel exceeds that of the panel or service rating, there are generally two options. Either the panel and/or service must be upgraded, or the new load must be managed to limit the service load. Upgrading a panel and/or service is an intensive and obstructive process, often requiring collaboration with the Local Distribution Company (LDC). Further, depending on the size of the service change that is required, electrical safety codes May require structural changes to the home where the service is located to achieve a higher level of safety.

Given the complexities of a panel or service upgrade, load management approaches are particularly advantageous. However, most current load management approaches require significant upgrade, change, or renewal of the existing infrastructure. For example, requiring a complete replacement of the existing distribution panel with a smart panel, installation of a separate load management module that needs to be programmed and wired back to the main panel, installation of a separate single-circuit load shedding controller (which also requires additional wiring space and has limited scalability and adaptability to serve future load growth needs), or the like. Embodiments of the present disclosure advantageously overcome the limitations of other approaches by providing flexible load management that can easily integrate with an existing panel and provide future scalability.

Additionally, back-up power systems are becoming increasingly prevalent and desired throughout an electrical distribution grid. In back-up power applications, generally distribution is scaled to serve only the critical loads of a facility or building. To ensure that only critical loads will be powered, and that the appropriately scaled back-up power system will not be overloaded, it is generally necessary to shed non-critical loads (i.e., open-circuit) in an outage condition. In order to shed these loads, often a separate breaker panel is installed, to which all back-up loads are moved. A central transfer switch is then installed between the main breaker panel and the sub-panel to ensure the critical loads are isolated from the grid as well as the non-critical loads. The installation of this second breaker panel and transfer of loads is labor, cost, and material intensive, requiring several hours of professional labour, new breakers, and new copper wire; all of which make back-up systems less accessible. Embodiments of the present disclosure advantageously overcome the limitations of other back-up approaches by integrating with an existing breaker panel in order to automatically shed non-critical loads to the power capabilities of the back-up system in response to the presence of grid power or lack thereof.

Generally, even in cases where a load is physically reduced via separate critical loads panel, there may still be inefficiency in the distribution of power in cases where the back-up supply is battery storage-based. The degree of “criticality” of a given load may be dependent on the amount of back-up resource available; for example, at 80% battery charge, a stove may be considered a critical load, but once charge reduces to 15%, perhaps only a fridge and Wi-Fi may be considered critical enough to continue drawing power. Embodiments of the present disclosure advantageously provide the ability to change the load dynamically in response to variable priorities.

One particular approach for automated load management includes the installation of a “smart panel”. Such panels replace a traditional breaker panel with a remotely controllable, Internet-of-things (IoT) alternative; such that any circuit in a home can be measured in real time and remotely turned on or off. This functionality is achieved by replacing a traditional panel bus with an integrated circuit board, such that the power supply to each breaker terminal flows from the main lugs of the panel, through a current sensing device and contactor before reaching the breaker terminal. The terminals can then be compatible with a variety of industry standard breakers. Smart panels suffer from a number of substantial disadvantages. For example, they require excessive complexity, feature set, and material when control is only required on a few key loads for capacity management or non-critical load shedding. There are generally requirements for third party ownership/storage of household energy consumption data. Such panels generally require utility companies to disconnect power to a building in order to replace entire breaker panel. Further, such panels generally require excessive labour to replace and rewire entire breaker panels during a time when an existing panel and breakers are uncompromised and have plenty of useful life remaining.

Another approach for automated load management includes use of a “load management box”. Such load management boxes can be strategically applied to select circuits in a home, without needing to replace an entire breaker panel. For example, by installing a separate Wi-Fi-connected control box adjacent to an existing breaker panel. Select circuits are then routed through that control box via new jumper wires (2 wires per load). Inside the control box, the circuits pass through a measuring device, and a contactor enabling certain “smart” functionalities. The control box can also contain a Wi-Fi gateway and ports for measuring the current draw at the service entrance. The control box can be powered from the main panel on a 15 A breaker and may also require bonding to transfer ground reference. However, load management boxes suffer from a number of substantial disadvantages. For example, such boxes generally require available space to mount the box (e.g., 24″×24″), junctioning of existing feeders, and wiring to the box location via a conduit. Additionally, such boxes have excess complexity, feature set, and material requirements when control is only required on a few key loads for capacity management or non-critical load shedding. Further, such boxes generally require a digital installer for configuration. Further, due to the limitations of the installation of such boxes, they generally do not offer automated capacity management.

Another approach for automated load management includes use of a Wi-Fi enabled breaker. This approach allows typical analog breakers to be replaced with a digital breaker in order to allow control via an external gateway. In some cases, the breakers can be a part of a closed ecosystem, and therefore, not cross compatible with existing breaker panels of a different brand. However, Wi-Fi enabled breakers suffer from a number of substantial disadvantages. Such breakers generally rely on wireless communication to an external gateway to perform energy management functions. Further, such breakers generally occupy twice the space in a panel compared to a typical analog breaker, displacing existing circuits and leading to space limitations. Further, such breakers generally do not actively monitor service entrance current. Further, such breakers generally cannot provide reliable service capacity management or load shedding within an acceptable response time.

Another approach for automated load management includes use of a single circuit load shedding controller. However, such controllers are limited to one circuit and requires external space for wiring and associated wiring materials; both of which grow proportionately to the number of circuits being served.

Embodiments of the present disclosure advantageously provide automated, ‘intelligent’, and modular load management. Such embodiments can include mechanical compactness, bonding continuity, and pre-programmed functionality; such that the embodiments can be used inside a typical electrical panel. In this way, embodiments of the present disclosure can greatly simplify and reduce labour, space, material requirements, and configuration efforts required to achieve automated load management functionality.

In a particular embodiment, the load management provided in the present disclosure can include three operating modes. In two of such modes, onboard firmware is solely used for automated load shedding operations for capacity management and back-up load reduction applications. In this way, no external gateway, IoT, or external services are required. Onboard interface elements (e.g., mode button, breaker size indicator, or the like) can be provided such that various programmed functionality can be configured and used with physical controls; eliminating the need for digital configuration via app or over Wi-Fi. In a third mode, communication can take place with an internet-connected energy management gateway to perform further customized energy management tasks based on user inputs, or predictive modeling by the gateway, which can be communicated via a local communication protocol, such as a wireless or wired communication, to the gateway.

Advantageously, embodiments of the present disclosure are able to automatically provide limited service capacity or back-up power capacity with minimal labour and material requirements. Thus, providing a low barrier to entry by maximizing the use of existing infrastructure and, in some cases, providing the required functionality with onboard programming and mechanical configurability. Further, the invention allows for the desired functionality to be achieved without any Wi-Fi connection, remote control or user configuration, via a default, firmware driven approach resulting in lowest potential for configuration error. The invention can also be coupled via Modbus, or other local communication protocol, to a separate gateway device to provide further advanced energy management capabilities informed by the predictive control methods executed on the gateway device.

A load management system (LMS) is provided to enable flexible and automatic real time measurement and control of electric circuits within a building. This functionality can be achieved, for example, by installing an interrupting device (contactor) and a measurement device (hall effect, current transformer, or the like) in series with a load path of the electric circuit, along with a programmable device or processor that may respond to measurements to operate the interrupter. The present embodiments provide a number of advantages, for example, in a physical manifestation, ease of installation, maximal compatibility with existing systems, minimal material and space requirements, built-in response capability, and potential for lack of network requirement or active user engagement; which enables automatic load shedding functionality across multiple load channels in a self-contained unit.

Advantageously, the present embodiments can provide electric capacity management via automatic load shedding locally, rather than having to use general-purpose hardware that requires instructions from external sources.

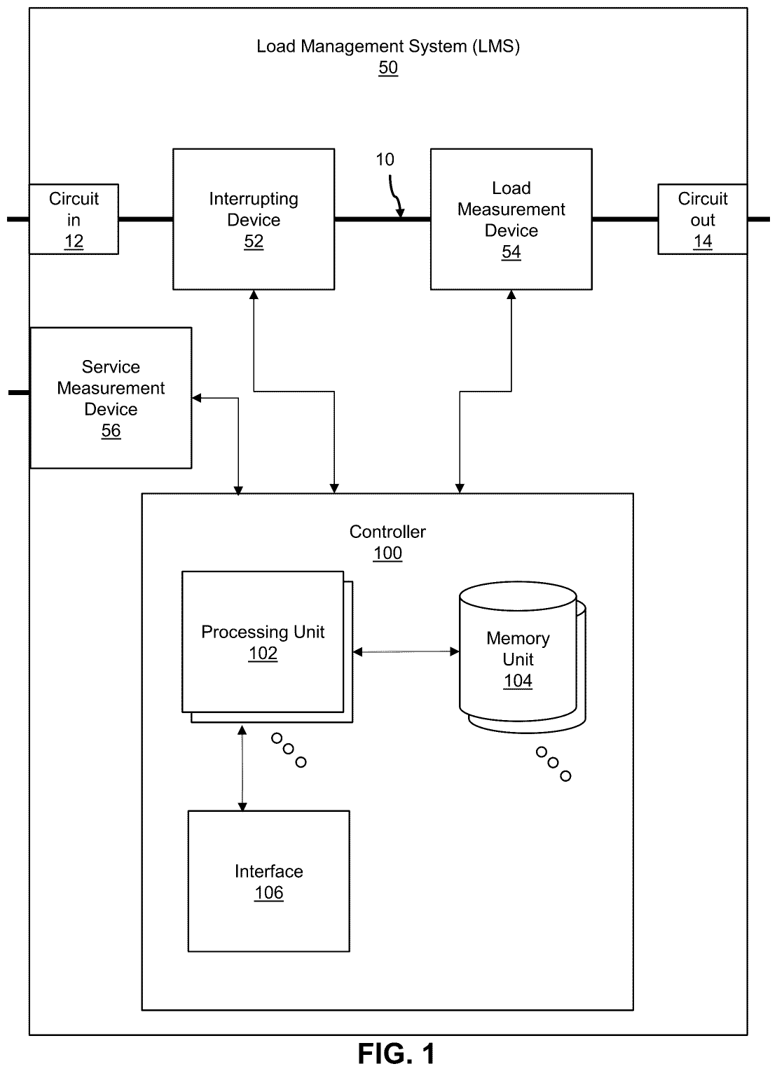

Turning to FIG. 1, shown therein is a diagram of an embodiment of a controller for automatic load shedding 100 located as part of a system for automatic load shedding 50 (informally referred to as a load management system (LMS)). The controller 100 includes one or more processing units 102 in communication with one or more memory units 104 and an interface 106. Each memory unit 104 comprising a non-transitory computer-readable medium. The processing units 102 can comprise microprocessors, microcontrollers, dedicated hardware circuits, or the like. The processing unit 102 executes instructions stored on the one or more memory units 104 to perform a number of method steps, as described herein. The controller 100 may include other components as applicable or suitable, such as a local bus enabling the one or more processing units 102 to communicate with the one or more memory units 104 and the interface 106. The controller 100, via the interface 106, communicates with one or more of the other components of the LMS 50, as described herein. In some cases, the controller 100, via the interface 106, can interface with the user, for example with a display and input device. In some cases, the controller 100 can also interface with other systems, via the interface 106, for example other computing devices and servers remotely located from the controller 100, such as a gateway device, an application programming interface (API), and/or cloud data storage/computing resources.

The LMS 50 enables the automatic real time measurement and control of electric circuits within a building or structure. The LMS 50 comprises an interrupting device (e.g., contactor) 52 and a load measurement device 54 (e.g., hall effect sensor, current transformer, or the like) in series with the load path of an electric circuit 10 via circuit in 12 and circuit out 14 connections. The LMS 50 also comprises a service measurement device 56 to measure the service entrance current of the electrical panel. The service measurement device 56, the load measurement device 54 and the interrupting device 52 are in communication with the controller 100. The controller 100 responds to measurements of the load measurement device 54 to operate the interrupting device 52. The physical manifestation of this arrangement for the described embodiments provide, as described herein, ease of installation, maximal compatibility with existing systems, minimal material and space requirements, and lack of network requirement or active user engagement.

The LMS 50 provides the ability to operate in a standalone manner, for example, separate from the operation of an Energy Management Controller (EMC). The LMS 50 allows for the ability o perform specific automated load shedding tasks in power outage or service capacity management conditions. In some cases, the LMS 50 provides the ability to function in conjunction with the EMC to perform an additional suite of smart energy management functions, and adaptive or user driven responses to capacity management or outage conditions.

The LMS 50 provides modularity to allow for adaptability across a range of applications. The LMS 50 achieves modularity via a master-slave architecture, where certain critical functions (for example, voltage sensing, power supply, service measurement, and control) are centralized to a master module. Each slave module includes a number of load management channels (for example, four channels). In some cases, differential signals can be used for board-to-board communication to allow daisy-chaining for flexible positioning of the modules within the breaker panel; significantly easing installation.

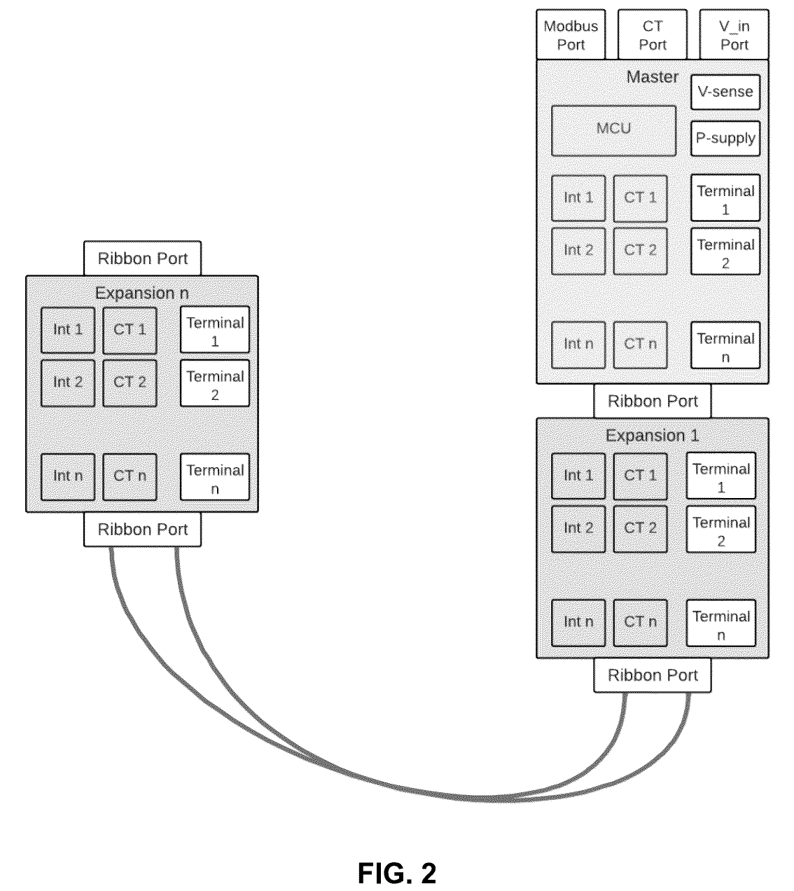

FIG. 2 illustrates an example architectural schematic of the LMS 50, showing the described modularity. In this example, the master board includes the controller 100 (‘MCU’), terminal blocks (‘Terminal 1’, ‘Terminal 2’, ‘Terminal n’), contactors (‘INT 1’, ‘INT 2’, ‘INT n’), current sensors (‘CT 1’, ‘CT 2’, ‘CT n’), a voltage sensing circuit (‘V-sense’), a rectifier/power supply circuit (‘P-supply’), a mode selector switch (not shown), a power terminal (‘V_in Port’), a current transformer terminal (‘CT Port’), current transformers for service entrance monitoring (not shown), two Modbus ports (1 EMC, 1 expansion), a metallic housing, and a ribbon port to connect to the slave boards. In this example, the slave board (or ‘expansion board’) includes terminal blocks (‘Terminal 1’, ‘Terminal 2’, ‘Terminal n’), contactors (‘INT 1’, ‘INT 2’, ‘INT n’), current sensors (‘CT 1’, ‘CT 2’, ‘CT n’), a metallic housing, and a ribbon port to connect to further slave boards. In this example, the contactors can be up to 60 A for managing typical loads.

In a non-limiting example, each slave board can accommodate up to four circuits and each master board can accommodate up to four slave boards. The modular architecture of the LMS 50 allows for maximum functionality that provides compatibility with minimum component count, complexity, and minimum breaker space allocation. Additionally, this arrangement allows a single reference voltage source to be applied to power management determinations for a number of circuits (or all circuits); rather than having to use distributed voltage referencing, which typically requires excessive wiring and isolation.

The LMS 50 can be powered from an alternating current (AC) voltage source. Since the power supply is required for standalone functions, it is substantially easier and safer to access the two poles on an AC power supply (L1 and L2) for sensing of a breaker, rather than, for example, tapping the main lugs of the circuit board. In some cases, the LMS 50 has terminals and circuitry for connecting to a service entrance in order to provide service entrance readings by the service measurement device 56 for capacity management, and to determine when grid power is lost. In many cases, it would not be appropriate to use voltage as an indicator of a power outage because if there is a back-up system, it will be automatically restored, but the current from the service feeder will go to zero.

In some cases, the LMS 50 can includes various user interface elements, such as buttons, switches, and indicators to set an operating mode. The operating modes can include, for example, a back-up (outage response) mode, a capacity management mode, and an EM-driven mode. In some cases, the LMS 50 can include “priority” channels for the capacity management mode; i.e., to shed priority loads first and non-priority loads subsequently if still necessary. In some cases, EMC mode channels can be configured with their load and function category; i.e., for capacity load, critical load, non-critical load, and the like.

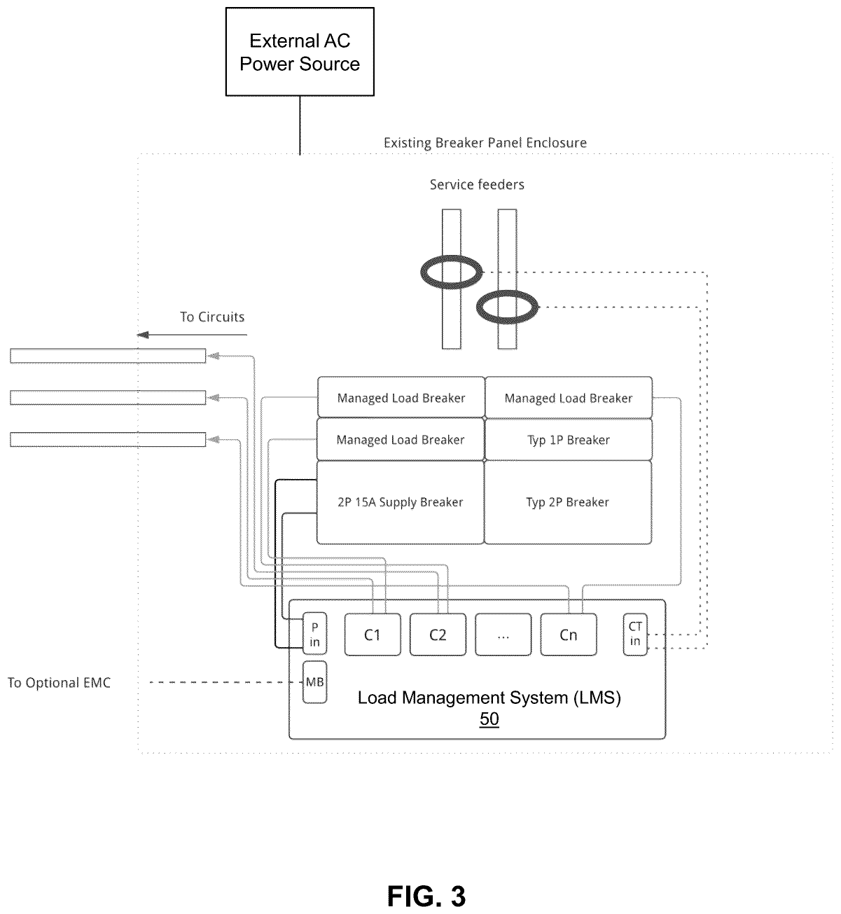

FIG. 3 illustrates a schematic diagram of an example incorporation of the LMS 50 into an existing breaker panel enclosure. Each of the circuits (‘C1’, ‘C2’, ‘Cn’) are connected to the respective terminal blocks (‘Terminal 1’, ‘Terminal 2’, ‘Terminal n’), contactors (‘INT 1’, ‘INT 2’, ‘INT n’), and current sensors (‘CT 1’, ‘CT 2’, ‘CT n’) of the LMS 50. The power terminal (‘V_in Port’) is connected to a type 2P supply breaker and the current transformer terminal (‘CT Port’) is connected to the service feeders. In some cases, the Modbus port can be connected to an EMC.

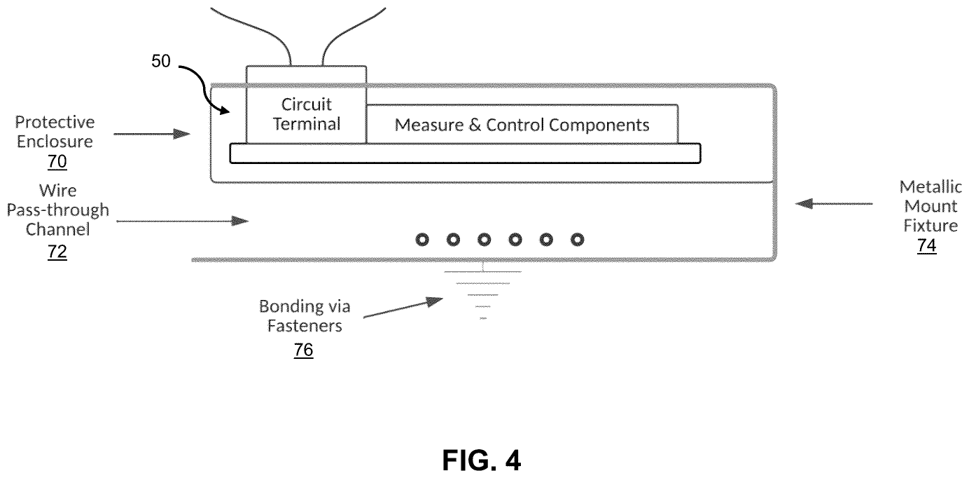

FIG. 4 illustrates an example side-view of a mechanical schematic of an enclosure 70 for the LMS 50. In this example, the LMS 50 is located in a protective enclosure 70 that is part of a metallic mount fixture 74. The metallic mount fixture 74 can include a wire-pass through channel 72. The metallic mount fixture 74 can be mounted to the electrical panel using any suitable approach, such as with bonding with fasteners 76. In most cases, the enclosure 70 can include an aluminium mounting frame to be fixed inside the breaker panel via, for example, self tapping screws to provide grounding continuity. There can also be a polymer-based board cover to protect circuit components and provide access to terminals. This example enclosure 70 can fit at the bottom of a typical breaker panel, with a space for passthrough of existing wires.

In some cases, the LMS 50 can include an address switch associated with a main breaker rating (e.g., 100 A, 125 A, or 200 A).

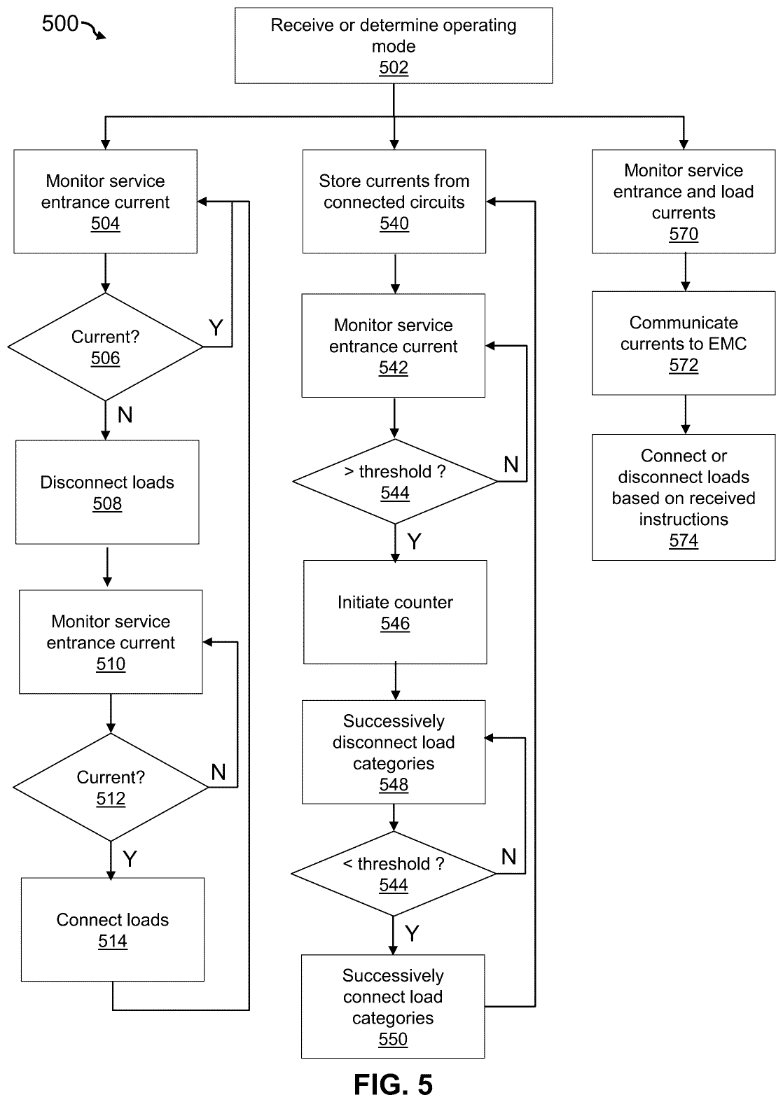

Turning to FIG. 5, shown therein is a flowchart of an embodiment of a method for automatic load shedding 500.

At block 502, the controller 100 receives instructions for an operating mode for the LMS 50 to operate in. The instructions can be received from the interface 106 via a user input device or over a network. It is understood that, in some cases, the controller 100 can operate in more than one mode concurrently. In standalone modes (the first and second modes), the LMS 50 can operate without communication with an EMC. In standalone modes, generally, the LMS 50 can have no knowledge of what load types are connected.

In a first mode, for outage load shedding, at block 504, the controller 100 receives current readings from the service entrance by the service measurement device 56. At block 506, the controller 100 monitors the current readings, and where the is current present, it continues to receive current readings. Where there is no current (i.e., power is out), the controller 100 instructs all the interrupting devices 52 to disconnect the connected loads. At block 510, the controller 100 returns to receiving the service entrance current. At block 512, where there is current present again, the controller 100 instructs all the interrupting devices 52 to connect the connected loads and returns to monitoring the service entrance current at block 504.

In another case of a outage load shedding mode, the controller 100 may communicate with an external transfer switch, via Modbus or other local communication protocol, or via an EMC, to monitor switch status. In this case, the controller 100 can use the transfer switch status information, rather than service entrance current, to ascertain the presence of grid power and execute load shedding. This case may be advantageous for certain electrical configurations where a double throw transfer switch is positioned upstream from the load centre.

In a second mode, for capacity management, the LMS 50 automatically sheds load based on priority if and when service entrance load gets to a predetermined percentage of the main breaker rating; for example, 80% of the main breaker rating. In such mode, the loads can be categorized and/or prioritized by their criticality; for example, a first category is the least critical and such loads are to be shed first, a second category is next least critical and are to be shed second, and the like.

At block 540, the controller 100 receives and stores currents from all, or most, connected circuits. In many cases, the controller can store a trailing average of the currents of the connected circuits; for example, a 5 second trailing average. At block 542, the controller 100 receives 4 repeated current readings of the service current from the service measurement device 56.

At block 544, if the root-mean-square (RMS) of the service current measurement is greater than a predetermined percentage of the main breaker rating (for example, greater than 80%), then, at block 546, the controller 100 initiates a counter that continues while the RMS value is above the threshold. The controller 100 continues the counter while the RMS value is above the predetermined threshold.

At block 548, the controller 100 disconnects categories of loads successively for each interrupt period. For example, when the counter reaches a first interrupt period, the controller instructs the loads on the first category (i.e., the least critical loads) to be disconnected, when the counter reaches a second interrupt period, the controller instructs the loads on the second category (i.e., the least critical loads) to be disconnected, and so on until the highest category of loads are disconnected, or the service current is reduced below the threshold. In some cases, certain categories of loads can be deemed too critical and will not be disconnected.

In another embodiment, the controller 100 can categorize load by load current instead of by priority. For example, when the first interrupt period is reached, the controller evaluates the load current of each channel and disconnects the largest consuming load. If the service current remains above the predetermined threshold, the controller proceeds to disconnects the highest remaining consumer of load upon the arrival of the second interrupt period, and so on. In further embodiments, the controller 100 can categorize load by a combination of load current and priority.

In many cases, the interrupt period can be dependent on the RMS level of the service current. For example: where the current level is 80% to 95% of the main breaker rating, the interrupt period can be 5 seconds; where the current level is 95% to 110% of the main breaker rating, the interrupt period can be 1 second; where the current level is 110% to 125% of the main breaker rating, the interrupt period can be 0.6 seconds; where the current level is 125% to 150% of the main breaker rating, the interrupt period can be 0.2 seconds; where the current level is 150% to 200% of the main breaker rating, the interrupt period can be 0.1 seconds; and where the current level is greater than 200% of the main breaker rating, the interrupt period can be 0.05 seconds.

At block 550, if the root-mean-square (RMS) of the service current measurement is less than the predetermined percentage of the main breaker rating, then, at block 552, the controller 100 successively connects categories of disconnected loads. Loads can be restored in reverse order from the order that the categories of loads were shed. For example, starting from the highest priority category of disconnected loads to the lowest priority category of disconnected loads. Alternatively, in the circuit load categorization embodiment, starting with the lowest consumer and working back to the largest consumer. In the restoration of loads, in most cases, the controller 100 ensures that for each load, restoration will not result in immediately exceeding the threshold. For example, the connection of the highest category of loads is restored when the combined value of the present service current and the stored trailing average current of the loads in this category is less than the predetermined percentage of the main breaker rating. Subsequently, the connection of the second highest category of loads is restored when the combined value of the present service current and the stored trailing average current of the loads in this category is less than the predetermined percentage of the main breaker rating. This restoration is continued until all the loads have been restored; i.e., the loads of the lowest category or highest consumer load have been restored.

In a third mode, adaptive load shedding, the LMS 50 can have full EMC functionality. In some cases, battery and/or solar status information can be incorporated. In some cases, the various loads can be labelled as appropriate. At block 570, the controller receives current measurements for the service entrance via the service measurement device 56 and for each of the connected loads via the load measurement devices 54. At block 572, the controller 100 can communicate the current measurements to the EMC via the interface 106 (such as via a web portal, Modbus, or local communication protocol). At block 574, the controller 100 can receive instructions to disconnect or connect specific loads, and the controller 100 can instruct the associated interrupting device 52 accordingly.

Use of the EMC allows for smart load shifting of flexible loads (for example, water heater, pool pump, EV charger) to maximize solar yield, or minimize cost of electricity in response to dynamic or Time-of-Use rates. For example, the controller 100 can connect various circuits for a minimum acceptable runtime when it may be most optimal to do so. This optimization can be determined by the EMC using predictive algorithms.

Use of the EMC also allows for adaptive load management in outage conditions; for example, load shedding that responds to battery status (load and state of charge) and forecasted resource potential. Additionally, for example, there may be the ability to apply duty cycles to critical loads during emergency battery level; for example, cycle a refrigerator on for 5 minutes every hour and a furnace for 10 minutes every hour in order to maximally extend services in very low resource conditions.

Use of the EMC also allows for reporting of irregular consumption conditions, or irregular power factor, which may indicate equipment issues. Also through the use of the EMC, users can remotely monitor and turn circuits on or off as desired.

While three modes are described with respect to the method 500, it is understood that the LMS 50 of the present embodiments can operate with only one or two of such modes.

The present embodiments advantageously provide a self-contained, modular load management device for control in series with 120/240V circuits. Embodiments can be mounted and bonded within an existing metallic enclosure of a typical 120/240V load centre. On-board load management can respond to loading conditions to automatically shed load in order to maintain a service capacity limit, and automatically restore those loads according to these conditions. The loading conditions may include current flow at one or more input feeders to the load centre, current flow at each of the managed loads, voltage at one or more input feeders to the load centre, or the like. Onboard load management advantageously reduces dependency on control responses from external servers, APIs, cloud databases, or external devices within a local wireless network; leading to greater reliability of accurate control actions. Onboard load management also advantageously greatly reduces the level of configuration effort required from an installer and/or user to properly establish the desired control response from the system. Further, mounting within an existing enclosure reduces material requirements, spatial requirements, and installation effort for integrating into an existing electrical system, thereby reducing barriers to adoption. Bonding to the existing metallic enclosure can be achieved via a fastening device; thus, reducing the likelihood of installer error and further reducing material requirements and installation effort.

The present disclosure provides an approach that can easily integrate with typical existing building power distribution panels to implement automated load management functions. The present embodiments can be used to implement load shedding and load shifting to achieve a limitation of total power flow into a constrained point of distribution. This serves at least two important roles: service capacity management under load growth conditions and back-up power conservation, and does so without requiring network and external controller dependencies.

Advantageously, the physical components of the system 50 can be implemented in a way that such components do not require much space, relative to other solutions. Such components can, in many cases, be integrated into a package that is mechanically compatible with a typical load centre and provides a wiring interface with a reasonable ease of use.

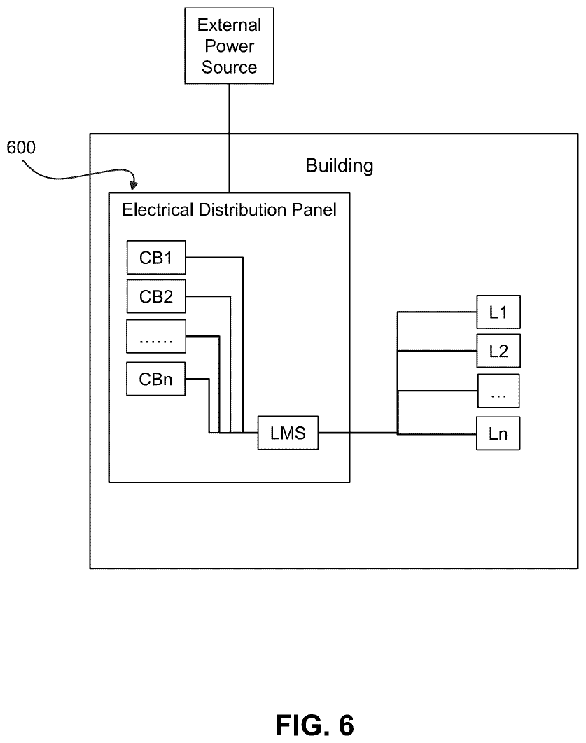

With reference to the accompanying figures, there is disclosed herein a system 50 for electrical load management that is associated with an electrical distribution panel 600 having a plurality of circuit breakers, such as those indicated at CB1, CB2 through CBn in FIG. 6, electrically connected to a plurality of a load circuits. The load circuits respectively include one or more electrical loads, such as those indicated at L1, L2 through Ln, which consume power. The electrical distribution panel 600 is arranged to be connected to an external power source, that is, a power source outside the building, as to receive a service entrance current. Typically, the external power source is a split-phase or multi-phase alternating current (AC) power source, such as mains power, in other words, an electrical utility grid.

The load management system 50 generally comprises:
a housing 70 arranged to be distinct from the electrical distribution panel 600;
one or more pairs of connection ports 12, 14 supported by the housing 70 and respectively defining a load path 10 between respective ones of the pair of connection ports for locating electrically in series between one of the circuit breakers and a corresponding one of the load circuits such that load current of the corresponding load circuit passes through the load path;
a service measurement device 56 supported by the housing 70 and configured to measure the service entrance current of the electrical distribution panel 600;
one or more circuit interrupter assemblies respectively disposed along the load paths 10 to receive the load currents arranged to pass therethrough, wherein each circuit interrupter assembly is supported within the housing 70 and comprises an interrupting device 52 and a load measurement device 54 electrically connected in series therewith, wherein the load measurement device 54 of each circuit interrupter assembly is configured to measure the load current and wherein the interrupting device 52 is configured to selectively form an open-circuit state for disconnecting the corresponding load circuit; and
a controller in operative communication with the service measurement device 56 and the one or more circuit interrupter assemblies including 52 and 54, the controller 100 comprising one or more processing units 102 in communication with a data storage 104 comprising executable instructions to:
   receive measurements of the service entrance current from the service measurement device 56;
   receive measurements of the load current from each load measurement device 54 of the one or more circuit interrupter assemblies; and
   configure selected ones of the interrupting devices 52 in the open-circuit states in response to a determination based on the measurements of the service entrance current and the load currents.

The housing 70 is distinct from the electrical distribution panel in that it is separate therefrom and from its enclosure. As such, the system 50 is a self-contained device that is retrofittable to an existing distribution panel.

Upon inserting a respective load path 10 electrically in series in a respective circuit of the building, by electrically connecting one of a respective pair of connection ports lying along the load path to a circuit breaker and another one of the respective pair of connection ports to a corresponding load circuit such that the load path is downstream from the circuit breaker, a current that would pass or flow through the circuit is transferred to the load path as to be wholly carried thereby.

When the external power source is a multi-phase AC power source, the service measurement device is preferably configured to measure current of each of the phases.

Each circuit interrupter assembly lies along one of the load paths to receive the corresponding load current passing therethrough. The interrupting device may be referred to as a relay. In the illustrated arrangement, the interrupting devices selectively form open-circuit states, in which they do not conduct current, in response to an external signal, that is a signal from another electronic device, in this case the controller 100. In the illustrated arrangement, without the external signals the interrupting devices form closed-circuit states in which they conduct current.

In the illustrated arrangement, the controller is in operative communication with the service measurement device measuring input current to the panel and the circuit interrupter assemblies by wired connection thereto.

The determination made by the controller and based on the current measurements includes selection or determination of an operating mode, such as the outage mode, adaptive load shedding mode, or adaptive load shifting mode, which determines how to relate the current measurements taken and identifies specific circuit interrupter assemblies in which the interrupting devices should switch state between closed-circuit and open-circuit.

In the illustrated arrangement, the housing 70 is configured to be mounted to a face of the electrical distribution panel, which may be an exterior or an interior face, and more specifically, that of an enclosure of the panel 600, which covers and surrounds the circuit breakers which are arranged in an array. In this way, the system 50 is retrofittable to an existing panel without occupying wall space around the panel.

In the illustrated arrangement, the system 50 includes a power terminal, which is indicated at ‘V_in port’, configured to be electrically connected to one of the circuit breakers to draw power from the electrical distribution panel 600. As such, the system 50 draws operating power locally from the panel 600, which power is preferably of AC type. In conjunction with this power terminal, the system 50 includes a voltage measurement device configured to measure voltage at the power terminal for determining voltage of the AC power signal from the electrical distribution panel. Thus, the system 50 can conveniently measure voltage of the service signal at the electrical panel for use in determining phase association and power factor of the respective circuits.

In the illustrated arrangement, the executable instructions of the controller include determining at least one of power factor and phase association of the load path operatively electrically connected to a respective electrical load to determine instructions for operating the interrupting device of the corresponding circuit interrupter assembly (connected to the circuit supplying current to that load). This may be performed by comparing voltage measured at input to the electrical distribution panel and current measured at an output connection port of each load path.

In the illustrated arrangement, the executable instructions to configure selected ones of the interrupting devices in the open-circuit states comprises configuring a respective interrupting device corresponding to the load path with a highest measured load current. In this way, prioritization of loads to be shed is based on current draw rather than predefined or fixed priorities of the loads, as to be dynamic and determined on-the-fly by the system 50.

In the illustrated arrangement, the executable instructions of the controller to configure selected ones of the interrupting devices to form the open-circuit states comprise configuring all of the interrupting devices in the open-circuit states as to disconnect all of the load circuits in an outage operational mode. The outage mode of operation of the LMS may be activated based on at least one of (i) the service entrance current being zero; and (ii) an external signal indicative of a power outage, for example, a signal transmitted from an automatic transfer switch or power inverter, configured to change state upon loss of grid power.

As shown in FIG. 2, in one of the illustrated arrangements, at least a first set of the connection ports and a first set of the circuit interrupter assemblies are carried on a master board carrying the controller 100 and a power terminal ‘V_in port’ configured to receive AC power, and a second set of the connection ports and a second set of the circuit interrupter assemblies are carried on a slave board in operative communication with the master board to receive the electrical power and the instructions of the controller from the master board. In the corresponding illustrated arrangement, there are plural slave boards. Operative connection between the master and slave boards is by wired connection via ribbon port.

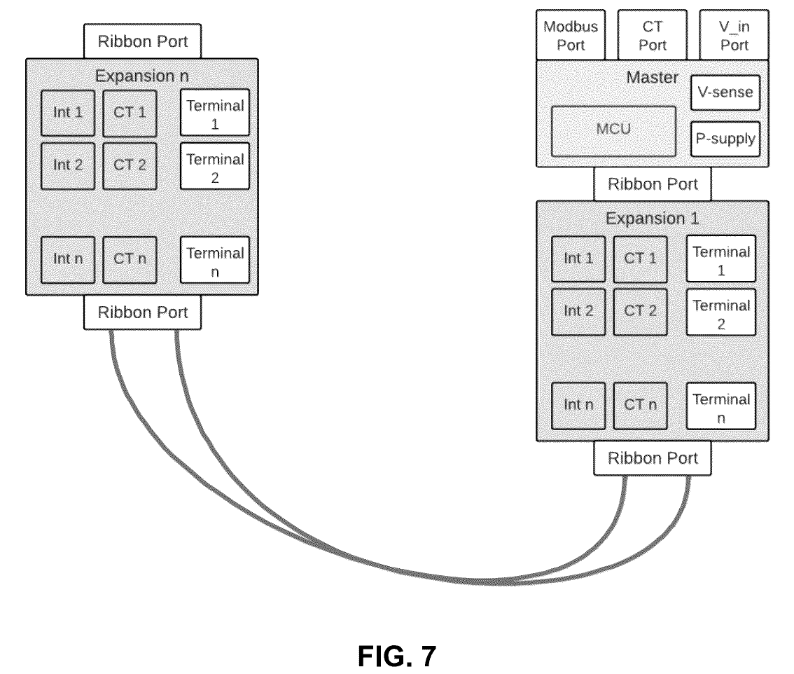

In another one of the illustrated arrangements shown in FIG. 7, the controller and a power terminal configured to receive AC power are carried on a master board and the connection ports and the circuit interrupter assemblies are carried on one or more slave boards in operative communication with the master board to receive electrical power and the instructions of the controller from the master board.

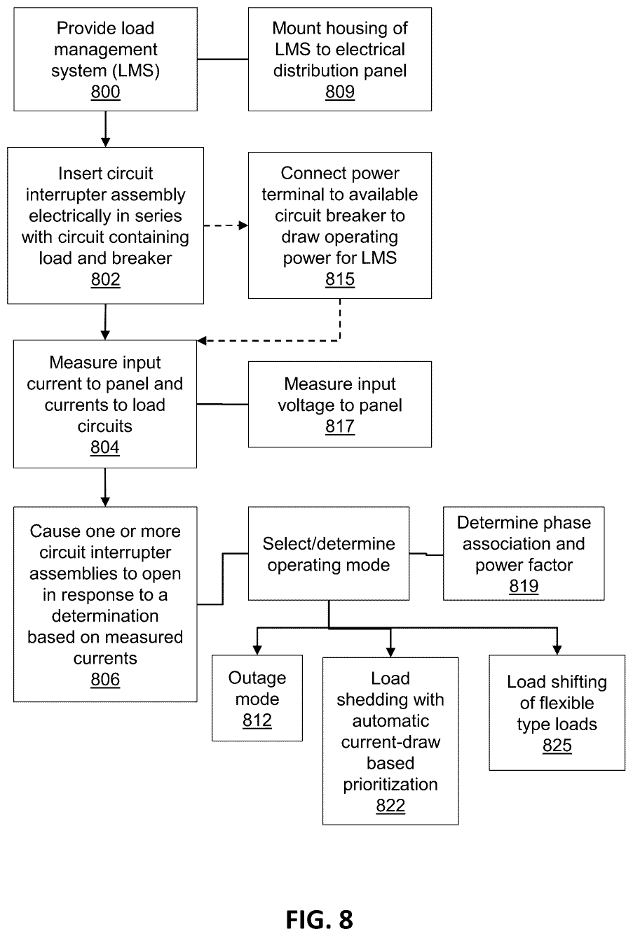

With reference to FIG. 8, there is also disclosed herein a method for managing electrical loads connected to an electrical distribution panel having a plurality of circuit breakers which are electrically connected to the circuit breakers as to form a plurality of circuits. The method generally comprises:
at block 800, providing a load management system distinct from the electrical distribution panel, wherein the load management system comprises a service current measurement device for measuring input current to the electrical distribution panel and one or more circuit interrupter assemblies for measuring currents of the electrical circuits and selectively opening to interrupt flows of the currents;
at block 802, electrically connecting one or more of the circuit interrupter assemblies in series with respective ones of the circuits between a corresponding one of the circuit breakers of the respective circuit and a corresponding one of the electrical loads of the circuits, wherein the circuit interrupter assemblies are connected between the corresponding circuit breaker and the corresponding load as to be downstream of the circuit breaker;
using the load management system, measuring the input current of the electrical distribution panel and the currents of the respective circuits connected to the load management system, as indicated at block 804; and
causing, using the load management system, one or more of the circuit interrupter assemblies to open to disconnect corresponding ones of the electrical loads of selected ones of the circuits in response to a determination based on the input current and the currents of the connected circuits, as indicated at block 806.

In the illustrated arrangement, the method further includes mounting the load management system to the electrical distribution panel at block 809.

In the illustrated arrangement, the step of causing one or more of the circuit interrupter assemblies to open comprises, as indicated at block 812, operating the one or more circuit interrupter assemblies in an outage mode in which all of the interrupting devices are configured to be open in response to at least one of (i) the service entrance current being zero, and (ii) an external signal indicative of a power outage.

In the illustrated arrangement, the method further includes electrically connecting the load management system to one of the circuit breakers to draw operating power therefrom, as indicated at block 815.

In the illustrated arrangement, the method further includes measuring, using the load management system, input voltage of the electrical distribution panel at electrical connection to one of the circuit breakers, as indicated at block 817. This may be performed concurrently or in parallel with measuring currents such as the service entrance current and load/circuit currents.

In the illustrated arrangement, the method further includes determining at least one of phase association and power factor of a respective circuit to determine instructions for operating a corresponding circuit interrupter assembly to interrupt flow of the current therethrough, as indicated at block 819. For example, split-phase loads require successive opening of multiple related circuit interrupters to completely interrupt current flow thereto. In another example, there may be phase imbalance in the current flow at the service entrance to be addressed in the control action. Notably, phase association and power factor are determined without requiring direct measurement of the circuit voltage passing through the circuit interrupter assembly.

In the illustrated arrangement, the step of causing one or more of the circuit interrupter assemblies to open comprises causing a respective circuit interrupter assembly connected to a respective circuit drawing a highest measured current to open, as indicated at block 822.

In the illustrated arrangement, the step of causing one or more of the circuit interrupter assemblies to open comprises, at block 825, toggling, between open and closed states, respective circuit interrupter assemblies connected to corresponding circuits including respective electrical loads of a flexible type, based on optimal energy usage information. Flexible type electrical loads may be periodically or intermittently powered without detriment to their end-use or function.

In the illustrated arrangement, toggling respective circuit interrupter assemblies between open and closed states is performed responsive to an external signal from a supervisory controller configured to predict optimal energy usage.

As described hereinbefore, in one aspect, the present invention relates to a system, controller, and method for automatic load shedding is provided. The system associated with a building electrical panel, the building electrical panel comprising a plurality of electrical circuits, the system including: a service measurement device to measure service entrance current and voltage of the building electrical panel; an interrupting device and a load measurement device located in series with a load path for each electrical circuit in the plurality of electrical circuits, the load measurement device measures load current on the electrical circuit, the interrupting device disconnects or connects connection of the electrical circuit upon receiving associated instructions; and a controller in communication with the service measurement device, each of the interrupting devices, and each of the measurement devices, the controller comprising one or more processing units in communication with a data storage including executable instructions to: receive service entrance current measurements from the service measurement device; receive load currents from the load measurement device; and instructs specific interrupting devices to disconnect electrical connection in response to load or capacity, or both, based on the service entrance current measurements and the load currents.

As described hereinbefore, in another aspect, the present invention relates to a system for load management of circuits connected to circuit breakers of an electrical distribution panel comprises a housing distinct from the panel; connection ports on the housing each pair of which defines a load path for locating electrically in series between a breaker and a load in a corresponding circuit such that load current of the circuit passes through the load path; a first current measurement device in the housing to measure input current to the panel; circuit interrupter assemblies respectively in the load paths each comprising a current interrupting device and a current measurement device in series therewith; and a controller in operative communication with the first current measurement device and the circuit interrupter assemblies and configured to (i) receive input panel current measurements, (ii) receive load current measurements, and (iii) configure selected interrupting devices in open-circuit states responsive to a determination based on said current measurements. A corresponding method for load management is also disclosed.

While the aspects of the present embodiments are illustrated and described as having a certain arrangement of aspects and features, it is understood that any suitable arrangement can be used that retains the functions described with respect to the present embodiments.

Although the foregoing has been described with reference to certain specific embodiments, various modifications thereto will be apparent to those skilled in the art without departing from the spirit and scope of the invention as outlined in the appended claims. The entire disclosures of all references recited above are incorporated herein by reference.

1. A system for electrical load management, wherein the system is associated with an electrical distribution panel having a plurality of circuit breakers electrically connected to a plurality of a load circuits, wherein the electrical distribution panel is arranged to be connected to an external power source as to receive service entrance current, the system comprising:
a housing arranged to be distinct from the electrical distribution panel;
one or more pairs of connection ports supported by the housing and respectively defining a load path between respective ones of the pair of connection ports for locating electrically in series between one of the circuit breakers and a corresponding one of the load circuits such that load current of the corresponding load circuit passes through the load path;
a service measurement device supported by the housing and configured to measure the service entrance current of the electrical distribution panel;
one or more circuit interrupter assemblies respectively disposed along the load paths to receive the load currents arranged to pass therethrough, wherein each circuit interrupter assembly is supported within the housing and comprises an interrupting device and a load measurement device electrically connected in series therewith, wherein the load measurement device of each circuit interrupter assembly is configured to measure the load current and wherein the interrupting device is configured to selectively form an open-circuit state for disconnecting the corresponding load circuit; and
a controller in operative communication with the service measurement device and said one or more circuit interrupter assemblies, the controller comprising one or more processing units in communication with a data storage comprising executable instructions to:
receive measurements of the service entrance current from the service measurement device;
receive measurements of the load current from each load measurement device of the one or more circuit interrupter assemblies; and
configure selected ones of the interrupting devices in the open-circuit states in response to a determination based on the measurements of the service entrance current and the load currents.

2. The system of claim 1, wherein the housing is configured to be mounted to a face of the electrical distribution panel.

3. The system of claim 1, wherein the executable instructions to configure selected ones of the interrupting devices to form the open-circuit states comprise instructions to configure all of the interrupting devices in the open-circuit states as to disconnect all of the load circuits in an outage operational mode.

4. The system of claim 1, further including a power terminal configured to electrically connect to one of the circuit breakers to draw power from the electrical distribution panel.

5. The system of claim 1, wherein at least a first set of the connection ports and a first set of the circuit interrupter assemblies are carried on a master board carrying the controller and a power terminal configured to receive AC power, and a second set of the connection ports and a second set of the circuit interrupter assemblies are carried on a slave board in operative communication with the master board to receive the electrical power and the instructions of the controller from the master board.

6. The system of claim 1, wherein the controller and a power terminal configured to receive AC power are carried on a master board and the connection ports and the circuit interrupter assemblies are carried on one or more slave boards in operative communication with the master board to receive electrical power and the instructions of the controller from the master board.

7. The system of claim 1, wherein, when the system includes a power terminal configured to be electrically connected to the electrical distribution panel to receive AC power therefrom, the system further includes a voltage measurement device configured to measure voltage at the power terminal for determining voltage of the AC power signal from the electrical distribution panel.

8. The system of claim 1, wherein the executable instructions of the controller include instructions to determine at least one of power factor and phase association of the load path operatively electrically connected to a respective one of the electrical loads to determine instructions for operating the interrupting device of the corresponding circuit interrupter assembly.

9. The system of claim 1, wherein the executable instructions to configure selected ones of the interrupting devices in the open-circuit states comprises configuring a respective one of the interrupting devices corresponding to the load path with a highest one of the measured load currents.

10. A method for managing electrical loads connected to an electrical distribution panel having a plurality of circuit breakers, wherein the electrical loads are electrically connected to the circuit breakers as to form a plurality of circuits, the method comprising:
providing a load management system distinct from the electrical distribution panel, wherein the load management system comprises a service current measurement device for measuring input current to the electrical distribution panel and one or more circuit interrupter assemblies for measuring currents of the electrical circuits and selectively opening to interrupt flows of the currents;
electrically connecting one or more of the circuit interrupter assemblies in series with respective ones of the circuits between a corresponding one of the circuit breakers of the respective circuit and a corresponding one of the electrical loads of the circuits, wherein the circuit interrupter assemblies are connected between the corresponding circuit breaker and the corresponding load as to be downstream of the circuit breaker;
using the load management system, measuring the input current of the electrical distribution panel and the currents of the respective circuits connected to the load management system; and
causing, using the load management system, one or more of the circuit interrupter assemblies to open to disconnect corresponding ones of the electrical loads of selected ones of the circuits in response to a determination based on the input current and the currents of the connected circuits.

11. The method of claim 10, further including mounting the load management system to the electrical distribution panel.

12. The method of claim 10, wherein causing one or more of the circuit interrupter assemblies to open comprises operating the one or more circuit interrupter assemblies in an outage mode in which all of the interrupting devices are configured to be open in response to at least one of (i) the service entrance current being zero, and (ii) an external signal indicative of a power outage.

13. The method of claim 10, further including measuring, using the load management system, input voltage of the electrical distribution panel at electrical connection to one of the circuit breakers.

14. The method of claim 10, further including electrically connecting the load management system to one of the circuit breakers to draw operating power therefrom.

15. The method of claim 10, further including determining at least one of power factor and phase association of a respective one of the circuits to determine instructions for operating a corresponding one of the circuit interrupter assemblies to interrupt flow of the current.

16. The method of claim 10, wherein causing one or more of the circuit interrupter assemblies to open comprises causing a respective one of the circuit interrupter assemblies connected to a respective one of the circuits drawing a highest one of the measured currents to open.

17. The method of claim 10, wherein causing one or more of the circuit interrupter assemblies to open comprises toggling, between open and closed states, respective ones of the circuit interrupter assemblies connected to corresponding ones of the circuits including respective ones of the electrical loads of a flexible type, based on optimal energy usage information.

18. The method of claim 17 wherein toggling respective circuit interrupter assemblies between open and closed states is performed responsive to an external signal from a supervisory controller configured to predict optimal energy usage.
